(19) United States
(12) Patent Application Publication
(10) Pub. No.: US 2013/0089152 A1
(43) Pub. Date: Apr. 11, 2013

(54) SIGNALING PICTURE IDENTIFICATION FOR VIDEO CODING

(71) Applicant: Qualcomm Incorporated, San Diego, CA (US)

(72) Inventors: Ye-Kui Wang, San Diego, CA (US); Ying Chen, San Diego, CA (US); Rajan Laxman Joshi, San Diego, CA (US)

(73) Assignee: QUALCOMM INCORPORATED, San Diego, CA (US)

(21) Appl. No.: 13/645,310

(22) Filed: Oct. 4, 2012

Related U.S. Application Data
(60) Provisional application No. 61/543,756, filed on Oct. 5, 2011.
(60) Provisional application No. 61/638,400, filed on Apr. 25, 2012.

(51) Int. Cl. H04N 7/26

(52) U.S. Cl. CPC H04N 19/00951
USPC 375/240.23

(57) ABSTRACT

In one example, a video coder, such as a video encoder or video decoder, is configured to determine a number of least significant bits of picture identifying information for a picture of video data, determine a value of the picture identifying information for the picture, and code information indicative of the determined number of least significant bits of the value of the picture identifying information for the picture.

This application claims the benefit of U.S. Provisional Application Ser. Nos. 61/543,756, filed Oct. 5, 2011, and 61/638,400, filed Apr. 25, 2012, which are hereby incorporated by reference in their respective entireties.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. A working draft of HEVC, “HEVC Working Draft 6” or “WD6,” is described in document JCTVC-H1003, Bross et al., “High efficiency video coding (HEVC) text specification draft 6,” Joint Collaborative Team on Video Coding (JCT-VC) of ITU-T SG16 WP3 and ISO/IEC JTC1/SC29/WG11, 8th Meeting: San Jose, Calif., USA, February, 2012, which, as of Apr. 25, 2012, is available from http://phenix.int-evey.fr/jct/doc_end_user/documents/8_San %20Jose/wg 11/JCTVC-H1003-v22.zip. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for efficiently and error-resiliently signaling picture identification information, such as picture order count (POC) values. These techniques may be implemented, in some examples, without restricting the capability of long-term reference pictures. In some examples, the techniques include coding POC values for different pictures using various lengths, in bits, of values representative of the POC values. For example, different lengths of values may be used to signal POC values of pictures based on any or all of the different types for the pictures (e.g., whether the picture is a random access point (RAP) picture, and if so, what type of RAP picture), temporal layers to which the pictures correspond, or other characteristics.

In one example, a method includes determining a number of least significant bits of picture identifying information for a picture of video data based on a picture type for the picture, determining a value of the picture identifying information for the picture, and coding information indicative of the determined number of least significant bits of the value of the picture identifying information for the picture.

In another example, a device includes a video coder, such as a video encoder or video decoder, configured to determine a number of least significant bits of picture identifying information for a picture of video data based on a picture type for the picture, determine a value of the picture identifying information for the picture, and code information indicative of the determined number of least significant bits of the value of the picture identifying information for the picture.

In another example, a device includes means for determining a number of least significant bits of picture identifying information for a picture of video data based on a picture type for the picture, means for determining a value of the picture identifying information for the picture, and means for coding information indicative of the determined number of least significant bits of the value of the picture identifying information for the picture.

In another example, a computer-readable storage medium (e.g., a non-transitory computer-readable storage medium) has stored thereon instructions that, when executed, cause one or more processors to determine a number of least significant bits of picture identifying information for a picture of video data based on a picture type for the picture, determine a value of the picture identifying information for the picture, and code information indicative of the determined number of least significant bits of the value of the picture identifying information for the picture.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for signaling picture identification information, such as picture order count (POC) values.

FIG. 2 is a block diagram illustrating an example of a video encoder that may implement techniques for signaling picture identification information, such as POC values.

FIG. 3 is a block diagram illustrating an example of a video decoder that may implement techniques for signaling picture identification information, such as POC values.

FIG. 4 is a conceptual diagram illustrating a sequence of coded video pictures.

FIG. 5 is a flowchart illustrating an example method for encoding pictures and picture identifying information.

FIG. 6 is a flowchart illustrating an example method for encoding pictures and picture identifying information.

### DETAILED DESCRIPTION

In general, this disclosure describes techniques related to efficient and error resilient signaling of picture identification in video coding. When video data is captured or generated, a sequence of images may be captured (or generated) in display order (which is referred to as output order in video coding standards). For different purposes, encoded pictures (also referred to as “frames”) may be rearranged into a particular coding order (or decoding order) different than the display/output order. Therefore, prior to output/display, encoded frames may be decoded and reordered.

Two values are generally used to describe display order and coding order. Picture order count (POC) values are typically used to represent the output/display order of a particular frame. Thus, POC values may be used to identify pictures. Frame number (frame_num) values, or variables derived from frame number values, may also be used to identify pictures. Frame number values generally describe the coding order of frames, which is not necessarily the same as output/display order for the frames, as noted above.

In other words, in a coded video bitstream, some form of picture identification information, e.g., picture order count (POC) as in ITU-T H.264/AVC (advanced video coding), picture presentation time, or frame_num as in H.264/AVC, may be signaled for the decoding process to identify pictures used in inter prediction, decoded picture buffer (DPB) management operations such as marking, insertion and removal, and so on.

In H.264/AVC, both POC and frame_num are signaled for each coded picture, wherein three types of POC signaling, namely, POC type 0, POC type 1 and POC type 2, are supported, and the POC value is in the range of −2³¹ to 2³¹−1, inclusive. When the POC type is equal to 0, the LSBs (Least Significant Bits) of the POC value are signaled in the slice header, while the MSB (Most Significant Bits) of the POC value are derived by the decoder. Signaling of LSBs and derivation of MSBs in this manner is considered as an efficient way since fewer bits are signaled.

A proposal, JCTVC-F493 by Sjöberg et al, “Absolute signaling of reference pictures,” Joint Collaborative Team on Video Coding of ITU-T SG 16 WP3 and ISO/IEC JTC1/SC29/WG11, Torino Meeting, Jul. 22, 2011, was made to HEVC to reduce the amount of data that is signaled for a frame of data by signaling only POC values (rather than frame_num values), and to use only a relatively small number of bits to represent the POC values (in particular, the least significant bits (LSBs)). This proposal is available at http://phenix.int-evey.fr/jct/doc_end_user/documents/6_Torino/wg11/JCTVC-F493-v8.zip. In JCTVC-F493, a fixed-length POC, e.g., of 4 bits, is signaled in the slice header, and thus, the POC value is in the range of 0 to 15 when the POC length, which is signaled in the sequence parameter set, is 4 bits, or in the range of 0 to 31 when the POC length is 5 bits, and so on. In this manner, relatively small amounts of data are used to signal picture identifying information. The most significant bits have assumed values, based on nearby encoded frames in the bitstream. For example, rather than signaling a value representative of POC value “2185,” if a recently coded frame had the POC value “2180,” then the value “05” may be used to represent a current frame having POC value “2185.”

Accordingly, the reduced number of bits is premised on decoding of the bitstream from start to finish. However, many users watch videos from random points, e.g., by seeking to a particular temporal location. In particular, the term “random access” refers to decoding of a coded video bitstream starting from any coded picture, particularly when starting from a coded picture that is not the first coded picture in the bitstream. A coded picture picP may be referred to as a random access point when the following condition is true: when decoding starts from picP, all coded pictures following picture picQ, which may or may not be the same as picP, in both decoding order and output order, can be correctly decoded.

Moreover, random access points (RAPS) may be either instantaneous decoding refresh (IDR) RAP pictures or non-IDR RAP pictures. Non-IDR RAP pictures are defined as follows for a RAP picture, picR:
1) picR is not an IDR picture.
2) Let the POC of picR be rPoc, and let picA be a picture in the same coded video sequence and following picR in both decoding order and output order, and let the POC of picA be aPoc. When random access is performed at picR (i.e., the decoding starts from picR), all pictures that are in the same coded video sequence and follow picA in output order can be correctly decoded.

A non-IDR RAP picture, picR, is said to be a clean random access (CRA) picture if, when random access is performed at picR, all pictures that are in the same coded video sequence and follow picR in output order can be correctly decoded. Otherwise, picR is said to be a gradual decoding refresh (GDR) picture, again assuming that the picture is a non-IDR RAP picture.

Existing methods for signaling POC values, such as those discussed in JCTVC-F493, may encounter certain problems, such as problems associated with the limited POC range. In general, POC values cannot be negative, in such conventional techniques. Thus, use cases that may require negative POC values are disallowed. In one such use case, an IDR picture precedes a coded picture picA in decoding order but follows picA in output order, for improved error resilience purpose.

As another example, only reference pictures within the POC value range can be used for inter prediction reference in the conventional techniques. When the POC length is not large, decoded pictures further away in POC distance cannot be used for inter prediction reference. This essentially limits the capability of using long-term reference pictures, which can be used to provide significantly improved coding efficiency in at least in the following scenarios. In the first scenario, a much earlier background picture is used for inter prediction reference as a long-term reference picture. In the second scenario, long-term reference pictures are used for efficient encoding of interview-like sequences, wherein during one period an interviewee person is shown when talking and during another period the interviewer person is shown when talking, and so on.

Additionally, the POC type 0 in H.264/AVC may encounter an error resilience problem. If the length of the least significant bits (LSBs) of the POC value is not large, e.g., 4 bits, and if the bitstream is temporally scalable, then in an extracted bitstream subset containing one or more of the lower temporal layers, the gap of POC values may result in incorrect POC values of pictures. Consequently, the decoding result may become incorrect and the output process based on POC values may also be incorrect. An example is described as follows: an example temporal scalable bitstream has at least two temporal layers, with the lowest temporal layer having temporal_id equal to 0, and other temporal layers having temporal_id greater than 0. Pictures of the lowest temporal layer have POC values of 10*n, i.e., 0, 10, 20, 30, 40, . . . , and so on, and only 4 bits are used to signal the POC LSB; hence the LSB values are in the range of 0 to 15, inclusive. Thus, when the picture with POC value equal to 20, for which the POC LSB value is 4, is lost, the POC value of the picture with POC value equal to 30, for which the POC LSB value is 14, would be derived as equal to 14, and consequently for the following pictures the derived POC values would also be incorrect.

This disclosure describes techniques for efficient and error resilient signaling of picture identification, in light of the changes introduced by the HCTVC-F493 proposal to signal only POC values with reduced numbers of bits. For example, this disclosure describes techniques for efficiently and error resiliently signaling picture identification information, such as POC values, without restricting the capability of long-term reference pictures. Although POC values are described for purposes of example, other picture identification information can also be signaled in accordance with the techniques of this disclosure. Examples of the techniques of this disclosure may overcome the problems noted above, e.g., by increasing the POC length or POC LSB length to be sufficiently large, while also avoiding excess signaling overhead to avoid hurting coding efficiency.

In some examples, various lengths of LSBs of POC values are used for various types of pictures, e.g., random access points, and in some examples, types of random access points. The lengths of LSBs for POC values may also depend on a temporal layer for the corresponding picture, where various temporal layers may be used for temporal scalability. For example, pictures in a first temporal layer may correspond to video data of 15 frames per second (FPS), pictures up to a second temporal layer may correspond to video data of 30 FPS, pictures up to a third temporal layer may correspond to video data of 60 FPS, and pictures up to a fourth temporal layer may correspond to video data of 120 FPS. Accordingly, pictures at various temporal layers may be assigned different lengths for LSBs of POC values, in some examples.

Various data structures may be used to signal information relating to coded video data. Parameter sets are generally transmitted independently of coded frames, e.g., within independent network abstraction layer (NAL) units. Parameter sets include picture parameter sets (which apply to one or more individual pictures) and sequence parameter sets (which apply to one or more coded video sequences, e.g., starting from an IDR picture to the next IDR picture, or to the end of the bitstream).

Some examples of the techniques of this disclosure include signaling, in a sequence parameter set (SPS), the minimum number of bits used to represent the lengths of LSBs of POC values in a corresponding sequence of coded video frames. The SPS may also include data representative of the various lengths of LSBs used to represent POC values for various types of coded pictures in the corresponding sequence. For example, the SPS may indicate the number of different LSB lengths possible, and for each different LSB length, signal the corresponding length and the corresponding pictures (e.g., temporal layers). Alternatively, the LSB lengths may be signaled in a picture parameter set (PPS) or in an adaptation parameter set (APS).

In this manner, slices corresponding to random access pictures may signal, in the slice headers, full POC values, or signal POC values having LSB lengths attributed to random access pictures. For other slices, the POC values signaled in the slice headers may be signaled using LSBs having lengths as signaled in the corresponding SPS, PPS, or APS. Thus, the number of least significant bits of the POC value for a slice may be indicated by a corresponding SPS, PPS, or APS. A video decoder may determine whether a picture is a CRA picture by signaling in a network abstraction layer (NAL) unit header, where NAL units may encapsulate slices of coded video data. For example, CRA pictures may correspond to particular types of NAL units, e.g., NAL unit type “4.”

As an example, the length of POC values, in bits, may be as follows:

32 bits for CRA pictures

16 bits for non-CRA and non-IDR pictures at temporal layer 0

8 bits for pictures in temporal layers 1 and 2

4 bits for pictures in temporal layers greater than 2

As another example, the length of POC values, in bits, may be as follows:

16 bits for CRA pictures

8 bits for non-CRA and non-IDR pictures at temporal layer 0

6 bits for pictures in temporal layer 1

4 bits for pictures in temporal layers greater than 1

Again, the actual signaled value for a POC value may correspond to the least significant bits of the actual POC value; other bits of the POC value may be inferred.

Moreover, this disclosure describes examples of decoding processes for the POC value. In particular, the POC value may be coded in two parts: the most significant bits (MSBs) and the least significant bits (LSBs). The LSBs may be signaled, and a decoder may refer to the MSBs of a previously coded picture to reproduce the current POC value. Thus, the POC value of the previous picture may be split into two parts based on the length of the POC LSBs for the current picture.

For example, different lengths of LSBs may be used for coding of POC values for different types of pictures. The lengths may be based at least in part on whether the picture is a random access point (RAP), and if so, what type of RAP. As another example, different lengths may be used for coding of POC values for pictures that belong to different temporal layers, that is, pictures having different temporal_id values.

In one example, if the previous picture in decoding order is an IDR picture, both the MSB and LSB of the POC value of the current picture may be set equal to zero. Otherwise, let the value prevPOC be equal to the POC value of the previous picture in decoding order. The LSB of the previous picture (prevPOC_LSB) may be set equal to |prevPOC| % maxPOC_LSB, where ‘%’ corresponds to the modulo operator, which for A % B returns the remainder of A/B, and where |X| denotes the number of bits in (that is, the length of) X. The value prevPOC_MSB may be set equal to prevPOC−prevPOC_LSB. The least significant bits of the current picture POC value, POC_LSB, may be signaled in the slice header, as indicated above.

Then, the MSB of the current picture (POC_MSB) may be derived as follows:

IF ((POC_LSB < prevPOC_LSB) AND (prevPOC_LSB − POC_LSB)

>= maxPOC_LSB/2)
POC_MSB = prevPOC_MSB + maxPOC_LSB;

ELSE IF ((POC_LSB > prevPOC_LSB) AND (POC_LSB −
prevPOC_LSB) >

maxPOC_LSB/2)
POC_MSB = prevPOC_MSB − maxPOC_LSB;

ELSE

POC_MSB = prevPOC_MSB;

Then, the POC value may be set equal to POC_MSB+POC_LSB, where the addition represents concatenation in this instance. The POC value may be restricted according to minima and maxima signaled in the SPS and PPS, or by other reasonable restrictions.

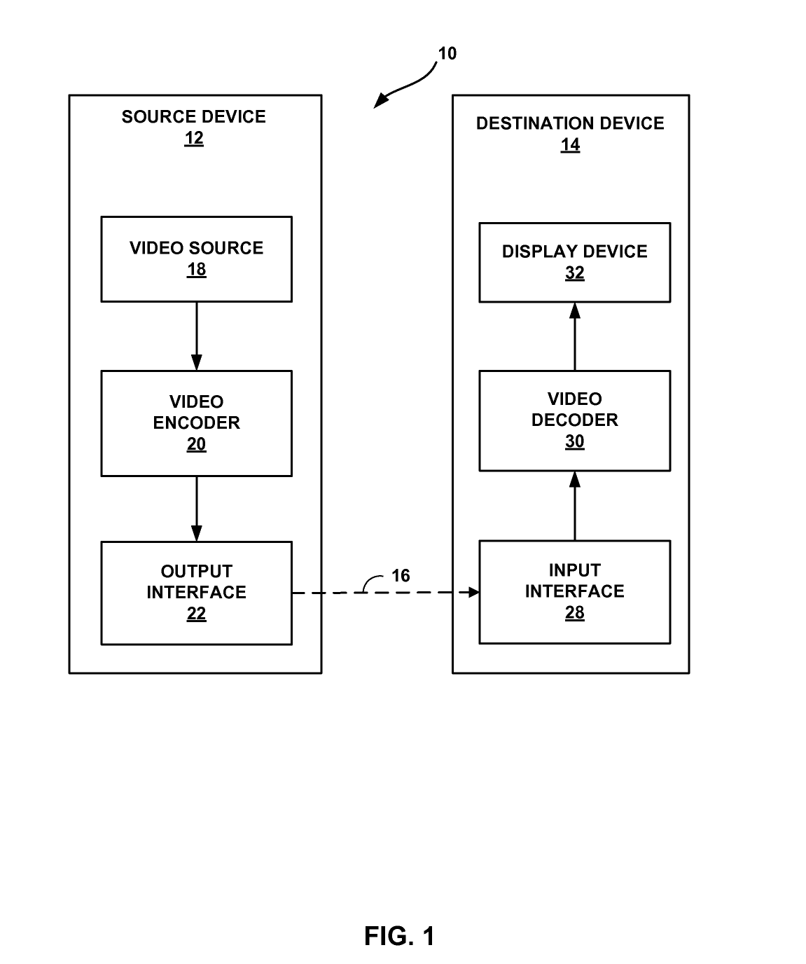

FIG. 1 is a block diagram illustrating an example video encoding and decoding system 10 that may utilize techniques for signaling picture identification information, such as picture order count (POC) values. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download.

The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for signaling picture identification information, such as POC values. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for signaling picture identification information, such as POC values may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 may operate according to a video coding standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video coding standards include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

In accordance with the techniques of this disclosure, a video coder, such as video encoder 20 and video decoder 30, may be configured to code LSBs of a POC value, and determine the number of bits in the LSBs based on one or more characteristics of a picture corresponding to the POC value. In some examples, different lengths of LSBs for coding POC values may be signaled in a parameter set, such as a video parameter set (VPS), a sequence parameter set (SPS), a picture parameter set (PPS), or an adaptation parameter set (APS). Table 1 below provides syntax for an example SPS raw byte sequence payload (RBSP):

TABLE 1

| seq_parameter_set_rbsp( ) { | Descriptor |
|---|---|
| profile_idc | u(8) |
| reserved_zero_8bits /* equal to 0 */ | u(8) |
| level_idc | u(8) |
| seq_parameter_set_id | ue(v) |
| max_temporal_layers_minusl | u(3) |
| pic_width_in_luma_samples | u(16) |
| pic_height_in_luma_samples | u(16) |
| bit_depth_luma_minus8 | ue(v) |
| bit_depth_chroma_minus8 | ue(v) |
| pcm_bit_depth_luma_minus1 | u(4) |
| pcm_bit_depth_chroma_minus1 | u(4) |
| log2_max_frame_num_minus4 | ue(v) |
| min_poc_lsb_len_minus2 | ue(v) |
| if(!max_temporal_layers_minus1) { | |
| num_add_poc_lsb_lens | ue(v) |
| for (i=0; i < num_poc_lsb_lens; i++) { | |
| max_temporal_id_poc_len[i] | u(3) |
| poc_len_delta_minus1[i] | ue(v) |
| } | |
| } | |
| poc_len_delta_rap | ue(v) |
| max_num_ref_frames | ue(v) |
| gaps_in_frame_num_value_allowed_flag | u(1) |
| log2_min_coding_block_size_minus3 | ue(v) |
| log2_diff_max_min_coding_block_size | ue(v) |
| log2_min_transform_block_size_minus2 | ue(v) |
| log2_diff_max_min_transform_block_size | ue(v) |
| log2_min_pcm_coding_block_size_minus3 | ue(v) |
| max_transform_hierarchy_depth_inter | ue(v) |
| max_transform_hierarchy_depth_intra | ue(v) |
| chroma_pred_from_luma_enabled_flag | u(1) |
| loop_filter_across_slice_flag | u(1) |
| sample_adaptive_offset_enabled_flag | u(1) |
| adaptive_loop_filter_enabled_flag | u(1) |
| pcm_loop_filter_disable_flag | u(1) |
| cu_qp_delta_enabled_flag | u(1) |
| temporal_id_nesting_flag | u(1) |
| inter_4x4_enabled_flag | u(1) |
| rbsp_trailing_bits( ) | |
| } | |

This example SPS includes additional data over the conventional SPS of HEVC, e.g., HEVC WD6. The additional syntax elements of the SPS of the example of Table 1 include min_poc_lsb_len_minus2, num_add_poc_lsb_lens, pairs of max_temporal_id_poc_len[i] and poc_len_delta_minus1[i], and poc_len_delta_rap. The semantics for these additional elements may be as defined below. The semantics for the other elements may be as defined in conventional HEVC.

min_poc_lsb_len_minus2 plus 2 may specify the minimum length, in bits, used to represent the pic_order_cnt_lsb syntax element. The value of min_poc_lsb_len_minus2 may be in the range of 0 to 14, inclusive.

num_add_poc_lsb_lens may specify the number of the following syntax element pairs max_temporal_id_poc_len[i] and poc_len_delta_minus1[i]. The value of num_add_poc_lsb_lens may be in the range of 0 to max_temporal_layers_minus1, inclusive. If not present, the value of num_add_poc_lsb_lens may be inferred to be equal to 0.

max_temporal_id_poc_len[i], poc_len_delta_minus1[i], and poc_len_delta_rap, together with min_poc_lsb_len_minus2, may specify the different lengths, in bits, used to represent the pic_order_cnt_lsb syntax element for different coded pictures. The value of max_temporal_id_poc_len[i] may be in the range of 0 to 7, inclusive. The value of poc_len_delta_minus1[i] may be in the range of 0 to 27, inclusive. The value of poc_len_delta_rap may be in the range of 0 to 27, inclusive. If not present, the value of max_temporal_id_poc_len[i] may be inferred to be equal to negative one (−1). If not present, the value of poc_len_delta_minus1[i] may be inferred to be equal to negative one (−1).

The variables PocLsbLen[i], for i values in the range of 0 to 7, inclusive, may be derived as follows:

len = min_poc_lsb_len_minus2 + 2
for(i = 0, tid = 7; i < num_add_poc_lsb_lens; i++)
{

maxtid = max_temporal_id_poc_len[ i ]
while(tid > maxtid)

PocLsbLen[ tid−− ] = len

len += poc_len_delta_minus1[ i ] + 1

}
while(tid > −1)

PocLsbLen[ tid−− ] = len

The variable PocLsbLenRap may be derived as follows:

PocLsbLenRap=PocLsbLen[0]+poc_{—}len_delta_{—}rap

In another example, the different lengths of LSBs for coding of POC values may be signaled in a parameter set, such as the example SPS of Table 2 below:

TABLE 2

| seq_parameter_set_rbsp( ) { | Descriptor |
|---|---|
| profile_idc | u(8) |
| reserved_zero_8bits /* equal to 0 */ | u(8) |
| level_idc | u(8) |
| seq_parameter_set_id | ue(v) |
| max_temporal_layers_minusl | u(3) |
| pic_width_in_luma_samples | u(16) |
| pic_height_in_luma_samples | u(16) |
| bit_depth_luma_minus8 | ue(v) |
| bit_depth_chroma_minus8 | ue(v) |
| pcm_bit_depth_luma_minus1 | u(4) |
| pcm_bit_depth_chroma_minus1 | u(4) |
| log2_max_frame_num_minus4 | ue(v) |
| min_poc_lsb_len_minus2 | ue(v) |
| num_add_poc_lsb_lens | ue(v) |
| for (i=0; i < num_poc_lsb_lens; i++) { | |
| max_temporal_id_poc_len[i] | u(3) |
| poc_len_delta_minus1[i] | ue(v) |
| } | |
| max_num_ref_frames | ue(v) |
| gaps_in_frame_num_value_allowed_flag | u(1) |
| log2_min_coding_block_size_minus3 | ue(v) |
| log2_diff_max_min_coding_block_size | ue(v) |
| log2_min_transform_block_size_minus2 | ue(v) |
| log2_diff_max_min_transform_block_size | ue(v) |
| log2_min_pcm_coding_block_size_minus3 | ue(v) |
| max_transform_hierarchy_depth_inter | ue(v) |
| max_transform_hierarchy_depth_intra | ue(v) |
| chroma_pred_from_luma_enabled_flag | u(1) |
| loop_filter_across_slice_flag | u(1) |
| sample_adaptive_offset_enabled_flag | u(1) |
| adaptive_loop_filter_enabled_flag | u(1) |
| pcm_loop_filter_disable_flag | u(1) |
| cu_qp_delta_enabled_flag | u(1) |
| temporal_id_nesting_flag | u(1) |
| inter_4x4_enabled_flag | u(1) |
| rbsp_trailing_bits( ) | |
| } | |

This example SPS includes additional data over the conventional SPS of HEVC, e.g., HEVC WD6. The additional syntax elements of the SPS of the example of Table 2 include min_poc_lsb_len_minus2, num_add_poc_lsb_lens, and pairs of max_temporal_id_poc_len[i] and poc_len_delta_minus1[i]. The semantics for these additional elements may be as defined below. The semantics for the other elements may be as defined in conventional HEVC.

min_poc_lsb_len_minus2 plus 2 specifies the minimum length, in bits, used to represent the pic_order_cnt_lsb syntax element. The value of min_poc_lsb_len_minus2 shall be in the range of 0 to 14, inclusive.

num_add_poc_lsb_lens specifies the number of the following syntax element pairs max_temporal_id_poc_len[i] and poc_len_delta_minus1[i]. The value of num_add_poc_lsb_lens shall be in the range of 0 to max_temporal_layers_minus1+1.

max_temporal_id_poc_len[i] and poc_len_delta_minus1[i], together with min_poc_lsb_len_minus2, specify the different lengths, in bits, used to represent the pic_order_cnt_lsb syntax element for different coded pictures. The value of max_temporal_id_poc_len[i] shall be in the range of 0 to 7, inclusive. The value of poc_len_delta_minus1[i] shall be in the range of 0 to 27, inclusive. If not present, the value of max_temporal_id_poc_len[i] shall be inferred to be equal to 0. If not present, the value of poc_len_delta_minus1[i] shall be inferred to be equal to −1.

The variables PocLsbLen[i], for i values in the range of 0 to 7, inclusive, are derived as follows:

len = min_poc_lsb_len_minus2 + 2
for(i = 0; i < 8; i++)

PocLsbLen[ i ] = len

for(i = 0; i < num_add_poc_lsb_lens−1; i++)
{

len += poc_len_delta_minus1[ i ] + 1
for (tid = max_temporal_id_poc_len[ i ] − 1; tid >=

max_temporal_id_poc_len[ i ]; tid−−)
PocLsbLen[ tid ] = len

}
len+= poc_len_delta_minus1[ i ] + 1
while(tid > −1)

PocLsbLen[ tid−− ] = len

if (!max_temporal_id_poc_len[ i ])

PocLsbLenRap = max_temporal_id_poc_len[ i ]

Table 3 below provides yet another example of syntax for an SPS. In this example, the length for coding of POC values for the highest temporal layer is signaled. In this example, if there is more than one temporal layer, the length for coding of POC values for each of the remaining lower temporal layers is signaled as a difference from the length for coding of POC for the next higher temporal layer. The difference in length may be constrained to be non-negative.

TABLE 3

| seq_parameter_set_rbsp( ) { | Descriptor |
|---|---|
| profile_idc | u(8) |
| reserved_zero_8bits /* equal to 0 */ | u(8) |
| level_idc | u(8) |
| seq_parameter_set_id | ue(v) |
| max_temporal_layers_minusl | u(3) |
| pic_width_in_luma_samples | u(16) |
| pic_height_in_luma_samples | u(16) |
| bit_depth_luma_minus8 | ue(v) |
| bit_depth_chroma_minus8 | ue(v) |
| pcm_bit_depth_luma_minus1 | u(4) |
| pcm_bit_depth_chroma_minus1 | u(4) |
| log2_max_frame_num_minus4 | ue(v) |
| min_poc_lsb_len_minus2 | ue(v) |
| if(!max_temporal_layers_minus1) { | |
| for(i=0; i < (max_temporal_layers_minus1); i++) { | |
| poc_len_delta[i] | ue(v) |
| } | |
| } | |
| max_num_ref_frames | ue(v) |
| gaps_in_frame_num_value_allowed_flag | u(1) |
| log2_min_coding_block_size_minus3 | ue(v) |
| log2_diff_max_min_coding_block_size | ue(v) |
| log2_min_transform_block_size_minus2 | ue(v) |
| log2_diff_max_min_transform_block_size | ue(v) |
| log2_min_pcm_coding_block_size_minus3 | ue(v) |
| max_transform_hierarchy_depth_inter | ue(v) |
| max_transform_hierarchy_depth_intra | ue(v) |
| chroma_pred_from_luma_enabled_flag | u(1) |
| loop_filter_across_slice_flag | u(1) |
| sample_adaptive_offset_enabled_flag | u(1) |
| adaptive_loop_filter_enabled_flag | u(1) |
| pcm_loop_filter_disable_flag | u(1) |
| cu_qp_delta_enabled_flag | u(1) |
| temporal_id_nesting_flag | u(1) |
| inter_4x4_enabled_flag | u(1) |
| rbsp_trailing_bits( ) | |
| } | |

This example SPS includes additional data over the conventional SPS of HEVC, e.g., HEVC WD6. The additional syntax elements of the SPS of the example of Table 3 include min_poc_lsb_len_minus2 and a loop of poc_len_delta[i] values. The semantics for these additional elements may be as defined below. The semantics for the other elements may be as defined in conventional HEVC, e.g., HEVC WD6.

min_poc_lsb_len_minus2 plus 2 may specify the minimum length, in bits, used to represent the pic_order_cnt_lsb syntax element. The value of min_poc_lsb_len_minus2 may be in the range of 0 to 14, inclusive.

poc_len_delta[i] together with min_poc_lsb_len_minus2, may specify the different lengths, in bits, used to represent the pic_order_cnt_lsb syntax element for different coded pictures. The value of poc_len_delta[i] may be in the range of 0 to (31−poc_len_delta[i+1]), inclusive. If not present, the value of poc_len_delta[i] may be inferred to be equal to 0.

The variables PocLsbLen[i], for i values in the range of 0 to (max_temporal_layers−1), inclusive, may be derived as follows:

len = min_poc_lsb_len_minus2 + 2
PocLsbLen[max_temporal_layers_minus1] = len
for(i = 0; i < (max_temporal_layers_minus1); i++)
{

len += poc_len_delta[i]
PocLsbLen[max_temporal_layers_minus1−1−i] = len

}

In some examples, the different lengths for coding of POC values may be signaled in the picture parameter set (PPS), which may include similar syntax and semantics as above in the examples of Tables 1-3. Furthermore, it may be restricted that the values of the variables PocLsbLen[i], for i values in the range of 0 to 7, inclusive, and the variable PocLsbLenRap derived from all picture parameter sets referring to one particular sequence parameter set may be identical, respectively.

In some examples, min_poc_lsb_len_minus2 is min_poc_lsb_len_minusN (with N being a different value than 2) and thus, the minimum length of POC LSBs may be N bits. For example, if N is 4, then the syntax element is min_poc_lsb_len_minus4 and the minimum length of POC LSB is 4 bits.

Table 4 below provides an example slice header syntax.

TABLE 4

| slice_header( ) { | Descriptor |
|---|---|
| lightweight_slice_flag | u(1) |
| if(!lightweight_slice_flag) { | |
| slice_type | ue(v) |
| pic_parameter_set_id | ue(v) |
| frame_num | u(v) |
| if(IdrPicFlag) | |
| idr_pic_id | ue(v) |
| else | |
| pic_order_cnt_lsb | u(v) |
| if(slice_type = = P \| \| slice_type = = B) { | |
| num_ref_idx_active_override_flag | u(1) |
| if(num_ref_idx_active_override_flag) { | |
| num_ref_idx_10_active_minus1 | ue(v) |
| if(slice_type = = B) | |
| num_ref_idx_11_active_minus1 | ue(v) |
| } | |
| } | |
| ref_pic_list_modification( ) | |
| ref_pic_list_combination( ) | |
| if(nal_ref_idc != 0) | |
| dec_ref_pic_marking( ) | |
| } | |
| if(entropy_coding_mode_flag && slice_type != I) | |
| cabac_init_idc | ue(v) |
| first_slice_in_pic_flag | u(1) |
| if(first_slice_in_pic_flag == 0) | |
| slice_address | u(v) |
| if(!lightweight_slice_flag) { | |
| slice_qp_delta | se(v) |
| if(sample_adaptive_offset_enabled_flag) | |
| sao_param( ) | |
| if(deblocking_filter_control_present_flag) { | |
| disable_deblocking_filter_idc | |
| if(disable_deblocking_filter_idc != 1) { | |
| slice_alpha_c0_offset_div2 | |
| slice_beta_offset_div2 | |
| } | |
| } | |
| if(slice_type = = B) | |
| collocated_from_10_flag | u(1) |
| if(adaptive_loop_filter_enabled_flag) { | |
| if(!shared_pps_info_enabled_flag) | |
| alf_param( ) | |
| alf_cu_control_param( ) | |
| } | |
| } | |
| } | |

This example slice header includes additional data over the conventional slice header of HEVC, e.g., HEVC WD6. The additional syntax element of the slice header of the example of Table 4 is pic_order_cnt_lsb. The semantics for this additional element may be as defined below. The semantics for the other elements may be as defined in conventional HEVC, with certain exceptions noted below.

When present, the value of the slice header syntax elements pic_parameter_set_id, frame_num (if present), idr_pic_id, and pic_order_cnt_lsb may be the same in all slice headers of a coded picture.

The variable CraPicFlag may be set equal to 1 if the slice belongs to a CRA picture. A CRA picture may be signaled by a particular value of nal_unit_type, e.g., 4.

In one alternative example, the variable CraPicFlag may be set equal to 1 if the slice belongs to a CRA picture, a GDR picture, or a long-term reference picture.

Let temporal_id of the coded slice NAL unit be tId. If CraPicFlag is equal to 1, the variable PocLength may be derived as equal to PocLsbLenRap. Otherwise, the variable PocLength may be derived as equal to PocLsbLen[tId].

The variable MaxPicOrderCntLsb may be derived as equal to 2^{PocLength}.

Alternatively, the above four paragraphs may be included in the text of NAL unit header semantics.

pic_order_cnt_lsb may specify the value of the variable PicOrderCntLsb used in the derivation of the picture order count of the coded picture as specified in subclause 4.3 of HEVC WD6. The length of the pic_order_cnt_lsb syntax element is PocLength bits. The value of the pic_order_cnt_lsb_syntax element shall be in the range of 0 to MaxPicOrderCntLsb−1, inclusive.

The variable PicOrderCntLsb may be derived as equal to pic_order_cnt_lsb.

For example, the value of PocLength may be equal to 32 for CRA pictures, 16 for non-CRA and non-IDR pictures with temporal_id equal to 0, 8 for pictures with temporal_id equal to 1 or 2, and 4 for pictures with temporal_id greater than 2. For another example, the value of PocLength may be equal to 16 for CRA pictures, 8 for non-CRA and non-IDR pictures with temporal_id equal to 0, 6 for pictures with temporal_id equal to 1, and 4 for pictures with temporal_id greater than 1.

More generally, an IDR picture may have zero POC LSBs, as shown in Table 4, because IDR pictures have POC values of zero. Therefore, there is no need to signal a POC value for the IDR pictures. Omitting signaling of POC values for IDR pictures may therefore achieve a bit savings.

Video encoder 20 may be configured to signal POC LSB lengths in data structures, as discussed in the examples above. Alternatively, video encoder 20 and video decoder 30 may be configured with pre-defined POC LSB lengths based on a type value for a picture, as discussed above. For example, video encoder 20 and video decoder 30 may be configured with a pre-defined length of 0 for POC LSBs for IDR pictures, and N (where N is a whole number) for POC LSBs for non-IDR pictures. Video decoder 30 may be configured to perform a POC decoding process in accordance with the example process below. The output of this process is referred to as “PicOrderCnt,” which corresponds to a POC value.

Picture order count values may be used to identify pictures, to determine co-located pictures (see subclause 8.4.1.2.1 of HEVC WD6) for deriving motion parameters in temporal or spatial direct mode, to represent picture order differences between frames for motion vector derivation in temporal direct mode (see subclause 8.4.1.2.3 of HEVC WD6), for implicit mode weighted prediction in B slices (see subclause 8.4.2.3.2 of HEVC WD6), and for decoder conformance checking (see subclause C.4 of HEVC WD6).

Each coded picture may be associated with one picture order count value, called PicOrderCnt. PicOrderCnt indicates the picture order of the corresponding picture relative to the previous IDR picture in decoding order.

If the current picture is an IDR picture, video decoder 30 may derive PicOrderCnt as equal to 0. Otherwise, video decoder 30 may perform the following.

Video decoder 30 may derive variables prevPicOrderCntMsb and prevPicOrderCntLsb as follows.

If the previous picture in decoding order is an IDR picture, prevPicOrderCntMsb may be set equal to 0 and prevPicOrderCntLsb may be set equal to 0.

Otherwise (if the previous picture in decoding order is not an IDR picture), video decoder 30 may perform the following.

Let prevPicOrderCnt be equal to PicOrderCnt of the previous picture in decoding order. The variable prevPicOrderCntLsb may be set equal to Abs(prevPicOrderCnt) % MaxPicOrderCntLsb, and the variable prevPicOrderCntMsb may be set equal to prevPicOrderCnt−prevPicOrderCntLsb.

Video decoder 30 may derive PicOrderCntMsb of the current picture as specified by the following pseudo-code:

if((PicOrderCntLsb < prevPicOrderCntLsb) &&

((prevPicOrderCntLsb − PicOrderCntLsb) >= (MaxPicOrderCntLsb /
2)))

PicOrderCntMsb = prevPicOrderCntMsb + MaxPicOrderCntLsb

else if((PicOrderCntLsb > prevPicOrderCntLsb) &&

((PicOrderCntLsb − prevPicOrderCntLsb) >

(MaxPicOrderCntLsb / 2)))

PicOrderCntMsb = prevPicOrderCntMsb − MaxPicOrderCntLsb

else

PicOrderCntMsb = prevPicOrderCntMsb

Video decoder 30 may then derive PicOrderCnt as

PicOrderCnt=PicOrderCntMsb+PicOrderCntLsb

In some examples, prevPicOrderCnt may instead be equal to PicOrderCnt of the previous reference picture in decoding order.

In some examples, prevPicOrderCnt may instead be equal to PicOrderCnt of the previous reference picture in decoding order with the same or lower temporal_id as the current picture.

In some examples, prevPicOrderCnt may instead be equal to PicOrderCnt of the previous picture in decoding order with the same or lower temporal_id as the current picture.

The value of PicOrderCnt may be restricted as follows—when the current picture is not an IDR picture, the following may apply:
1) Consider the list variable listD containing as elements the PicOrderCnt values associated with the list of pictures including all of the following:
   a. The first picture in the list is the previous IDR picture in decoding order, and
   b. All other pictures that follow in decoding order after the first picture in the list and either precede the current picture in decoding order or are the current picture. The current picture is included in listD prior to the invoking of the reference picture marking process.
2) Consider the list variable listO, which may contain the elements of listD sorted in ascending order of PicOrderCnt. listO may be restricted so as not to contain a PicOrderCnt that has a value equal to another PicOrderCnt.

In some examples, a restriction may be imposed that the bitstream shall not contain data that result in values of PicOrderCnt used in the decoding process that exceed the range of values from −2³¹ to 2³¹−1, inclusive.

In some examples, a restriction may be imposed that the bitstream shall not contain data that result in values of PicOrderCnt used in the decoding process that exceed the range of values from −2^{PocLsbLenRap-1} to 2^{PocLsbLenRap-1}−1, inclusive. In these examples, the PicOrderCnt of a CRA picture may be equal to the value of pic_order_cnt_lsb in the slice header of the slices of the CRA picture.

The function PicOrderCnt(picX) may be specified as follows:

PicOrderCnt(picX)=PicOrderCnt of the frame o picX

The function DiffPicOrderCnt(picA, picB) may be specified as follows:

DiffPicOrderCnt(picA,picB)=PicOrderCnt(picA)−PicOrderCnt(picB)

The bitstream may be restricted such that it shall not contain data that result in values of DiffPicOrderCnt(picA, picB) used in the decoding process that exceed the range of −2¹⁵ to 2¹⁵−1, inclusive.

In this example, let X be the current picture and Y and Z be two other pictures in the same sequence. Y and Z may be considered to be in the same output order direction from X when both DiffPicOrderCnt(X, Y) and DiffPicOrderCnt(X, Z) are positive or both are negative. Many encoders, outside of the techniques of this disclosure, assign PicOrderCnt proportional to the sampling time of the corresponding picture relative to the sampling time of the previous IDR picture.

Video encoder 20 may further send syntax data, such as block-based syntax data, frame-based syntax data, and GOP-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

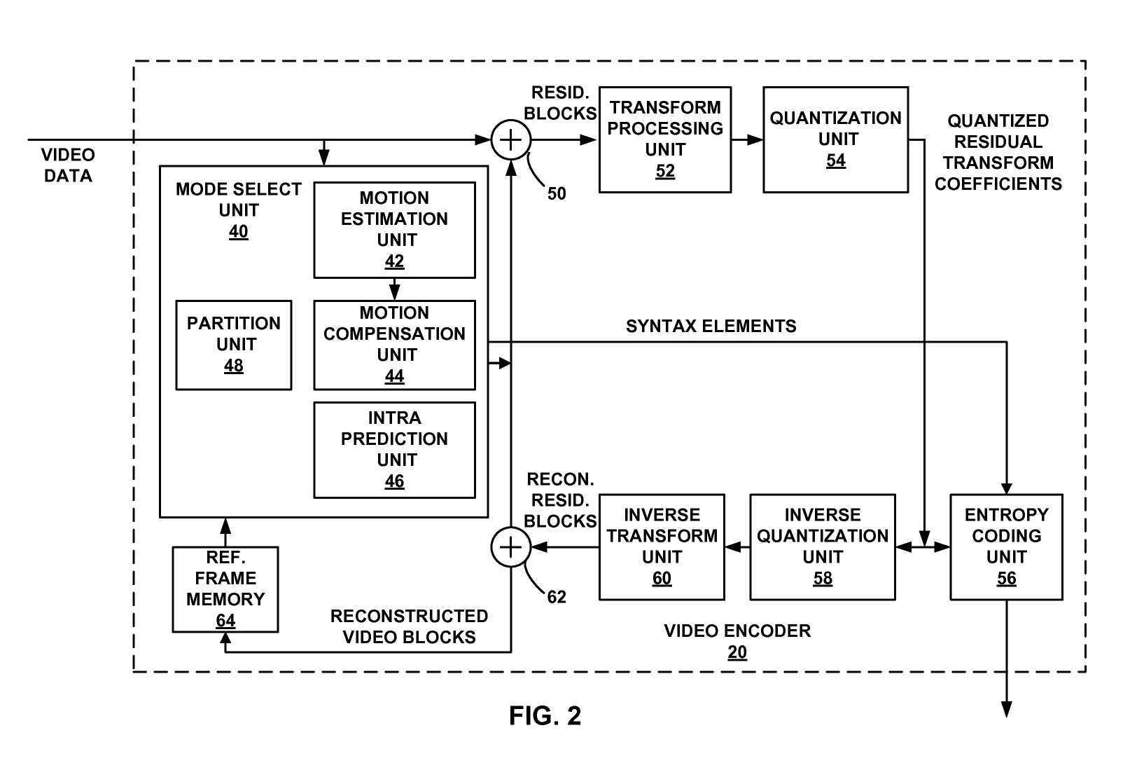

FIG. 2 is a block diagram illustrating an example of video encoder 20 that may implement techniques for signaling picture identification information, such as POC values. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes mode select unit 40, reference frame memory 64, summer 50, transform processing unit 52, quantization unit 54, and entropy coding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provide the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy coding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Pictures stored in reference frame memory 64 may each be associated with particular picture identifying information, such as picture order count (POC) values. For example, assuming reference frame memory 64 includes List 0 and List 1, data for List 0 and List 1 may include POC values of reference pictures for the respective lists. When coding a block of a current picture, e.g., a prediction unit (PU), video encoder 20 may code syntax data for the block representative of a reference picture in either List 0 or List 1 (e.g., an index into one of the lists), as well as a motion direction, which may be used to indicate whether the index corresponds to List 0 or List 1.

Video encoder 20 may code data representative of POC values for reference frames in a slice header of a slice of the picture, which may further be used to indicate how List 0 and List 1 are to be formed or modified. For example, video encoder 20 may signal POC values of reference frames to be included in the construction of List 0 and/or List 1, e.g., in the slice header. In accordance with the techniques of this disclosure, video encoder 20 may code a number of least significant bits (LSBs) of POC values of reference pictures to be included in the construction of List 0 and/or List 1 based on picture types for the reference pictures.

Video encoder 20 of FIG. 2 represents an example of a video encoder configured to determine a number of least significant bits of picture identifying information for a picture of video data based on a picture type for the picture, determine a value of the picture identifying information for the picture, and code information indicative of the determined number of least significant bits of the value of the picture identifying information for the picture. Video encoder 20 may code data corresponding to any or all of Tables 1-4 discussed above.

For example, as discussed with respect to Table 4, video encoder 20 may be configured to determine whether a picture is an instantaneous decoder refresh (IDR) picture. In particular, video encoder 20 may determine whether the picture type for the picture is an IDR picture. If the picture type for the picture is an IDR picture, video encoder 20 may determine that zero least significant bits (LSBs) of the picture identifying information are to be coded. Video encoder 20 may further determine that IDR pictures have zero-valued picture identifying information, and other pictures have non-zero-valued picture identifying information.

Video encoder 20 may determine that IDR pictures have a picture order count (POC) value equal to zero. Thus, the coded information indicative of the determined number of picture identifying information for a picture may comprise an indication that the picture is an IDR picture, which further signifies that zero bits (and, therefore, zero least significant bits) of picture identifying information are coded, per the example of Table 4. On the other hand, when the picture has a picture type other than an IDR picture (e.g., a clean random access (CRA) picture or a non-random access point (RAP) picture), video encoder 20 may code a value for a pic_order_cnt_lsb in a slice header of a slice of the picture, which corresponds to the coded information indicative of the number of least significant bits of a value for picture identifying information for the picture.

In this manner, video encoder 20 may be configured to code a slice header including identifying information (e.g., a POC value) for a slice of a current picture. Each slice having the same POC value may correspond to the same picture. Moreover, video encoder 20 may signal reference picture list construction and/or modification information using data representative of POC values, e.g., LSBs of POC values of reference pictures to be included in the reference picture lists. Thus, mode select unit 40 may select one of the reference pictures stored in either List 0 or List 1 of reference frame memory 64 to use to predict a current block of a current picture. Moreover, video encoder 20 may code syntax elements representative of the list from which a reference picture is selected, as well as an index corresponding to the reference picture in the list, for the current block.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy coding unit 56. Entropy coding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used.

In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy coding unit 56 entropy codes the quantized transform coefficients. For example, entropy coding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy coding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

It should also be understood that video encoder 20 may be configured to perform any or all of the techniques described with respect to FIG. 1 above, alone or in any combination.

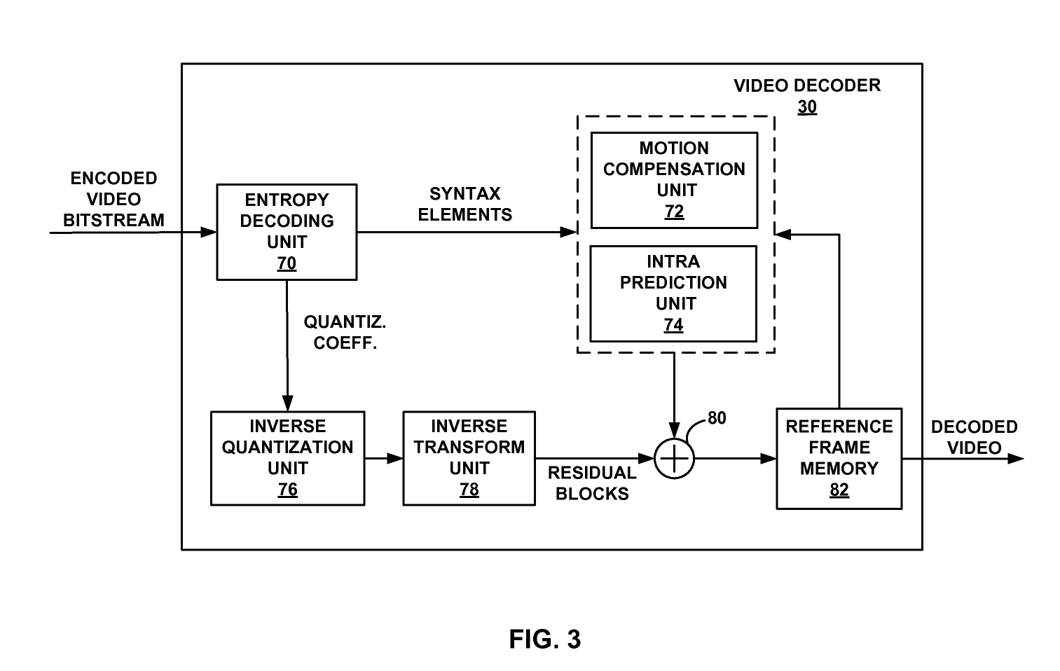

FIG. 3 is a block diagram illustrating an example of video decoder 30 that may implement techniques for signaling picture identification information, such as POC values. In the example of FIG. 3, video decoder 30 includes an entropy decoding unit 70, motion compensation unit 72, intra prediction unit 74, inverse quantization unit 76, inverse transform unit 78, reference frame memory 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B, P, or generalized P/B (GPB)) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference frame memory 92 and/or list modification data, such as ref_pic_list modification( ) data signaled in a slice header, as shown in Table 4 above.

Video decoder 30 of FIG. 3 represents an example of a video decoder configured to determine a number of least significant bits of picture identifying information for a picture of video data based on a picture type for the picture, determine a value of the picture identifying information for the picture, and code information indicative of the determined number of least significant bits of the value of the picture identifying information for the picture. Video decoder 30 may code data corresponding to any or all of Tables 1-4 discussed above.

For example, as discussed with respect to Table 4 above, video decoder 30 may determine that zero least significant bits (LSBs) are signaled for a POC value of an IDR picture, that is, a picture having a picture type indicating that the picture is an IDR picture. For other types of pictures, video decoder 30 may decode a value for pic_order_count_lsb, representing a number of LSBs signaled for the current picture. Moreover, video decoder 30 may receive data representative of POC values of reference pictures to be included in List 0 and/or List 1 when decoding the current picture. Then, using this received data representative of the POC values, video decoder 30 may form List 0 and/or List 1. Furthermore, when decoding a current block of the current picture, video decoder 30 may receive an indication of the list from which the current block is predicted (e.g., a motion direction), as well as an index into the list.

As noted above, video decoder 30 need not receive data representative of POC values for IDR pictures. For other types of pictures, video decoder 30 may receive LSBs for the respective POC values of the other pictures. Video decoder 30 may determine most significant bits (MSBs) for reference pictures using a POC value for a previously decoded picture, as discussed above with respect to the pseudocode described with respect to FIG. 1. After reconstructing POC values for each reference picture, video decoder 30 may assemble List 0 and/or List 1, e.g., using implicit and/or explicit list assembly techniques (and/or explicit or implicit list modification techniques). In general, implicit list assembly corresponds to pre-configuring video decoder 30 to assemble the list (e.g., ordering of reference frames within the list), whereas explicit list assembly corresponds to explicit instructions sent from video encoder 20 to video decoder 30 as to how to assemble the list.

In this manner, video decoder 30 may construct the reference picture lists (e.g., List 0 and/or List 1) in a manner conforming substantially to the construction performed by video encoder 20. Thus, the index value received by video decoder 30 for a current block corresponds to the same reference picture as used by video encoder 20 to encode the current block.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 80. The inverse quantization process may include use of a quantization parameter QP_{y} calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, video decoder 30 forms a decoded video block by summing the residual blocks from inverse transform unit 78 with the corresponding predictive blocks generated by motion compensation unit 82. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference frame memory 92, which stores reference pictures used for subsequent motion compensation. Reference frame memory 82 also stores decoded video for later presentation on a display device, such as display device 32 of FIG. 1.

Video decoder 30 of FIG. 3 represents an example of a video decoder configured to determine a number of least significant bits of picture identifying information for a picture of video data, determine a value of the picture identifying information for the picture, and code information indicative of the determined number of least significant bits of the value of the picture identifying information for the picture.

It should also be understood that video decoder 30 may be configured to perform any or all of the techniques described with respect to FIG. 1 above, alone or in any combination.

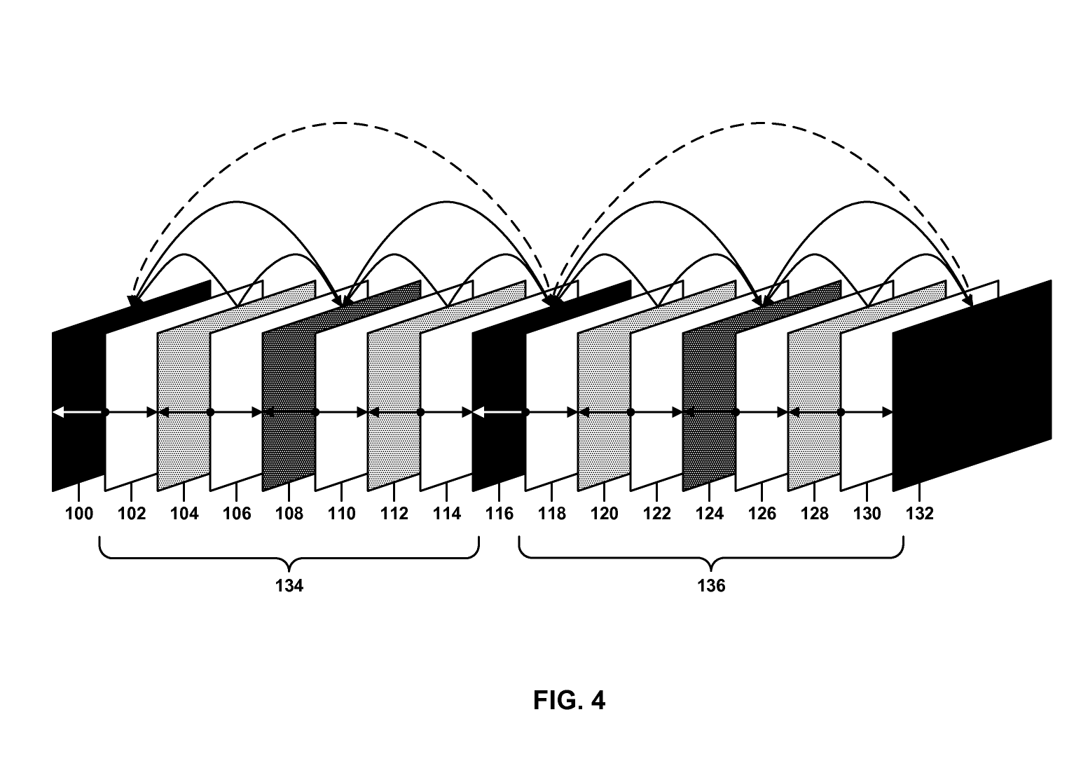

FIG. 4 is a conceptual diagram illustrating a sequence of coded video pictures 100-132. The pictures are shaded differently to indicate positions within a hierarchical prediction structure. For example, pictures 100, 116, and 132 are shaded black to represent that pictures 100, 116, 132 are at the top of the hierarchical prediction structure. Pictures 100, 116, 132 may comprise, for example, intra-coded pictures or inter-coded pictures that are predicted from other pictures in a single direction (e.g., P-pictures). When intra-coded, pictures 100, 116, 132 are predicted solely from data within the same picture. When inter-coded, picture 116, for example, may be coded relative to data of picture 100, as indicated by the dashed arrow from picture 116 to picture 100. Pictures 116, 132 form key pictures of groups of pictures (GOPs) 134, 136, respectively.

Pictures 108, 124 are darkly shaded to indicate that they are next in the encoding hierarchy following pictures 100, 116, and 132. Pictures 108, 124 may comprise bi-directional, inter-mode prediction encoded pictures. For example, picture 108 may be predicted from data of pictures 100 and 116, while picture 124 may be predicted from pictures 116 and 132. Pictures 104, 112, 120, and 128 are lightly shaded to indicate that they are next in the encoding hierarchy following pictures 108 and 124. Pictures 104, 112, 120, and 128 may also comprise bi-directional, inter-mode prediction encoded pictures. For example, picture 104 may be predicted from pictures 100 and 108, picture 112 may be predicted from pictures 108 and 116, picture 120 may be predicted from picture 116 and 124, and picture 128 may be predicted from picture 124 and 132.

Finally, pictures 102, 106, 110, 114, 118, 122, 126, and 130 are shaded white to indicate that these pictures are last in the encoding hierarchy. Pictures 102, 106, 110, 114, 118, 122, 126, and 130 may be bi-directional, inter-mode prediction encoded pictures. Picture 102 may be predicted from pictures 100 and 104, picture 106 may be predicted from pictures 104 and 108, picture 110 may be predicted from pictures 108 and 112, picture 114 may be predicted from pictures 112 and 116, picture 118 may be predicted from picture 116 and 120, picture 122 may be predicted from pictures 120 and 124, picture 126 may be predicted from pictures 124 and 128, and picture 130 may be predicted from pictures 128 and 132.

Pictures 100-132 are illustrated in display order. That is, following decoding, picture 100 is displayed before picture 102, picture 102 is displayed before picture 104, and so on. However, due to the encoding hierarchy, pictures 100-132 may be decoded in a different order. Moreover, after being encoded, pictures 100-132 may be arranged in decoding order in a bitstream including encoded data for pictures 100-132. For example, picture 116 may be displayed last among pictures of GOP 134. However, due to the encoding hierarchy, picture 116 may be decoded first among the pictures of GOP 134. That is, in order to properly decode picture 108, for example, picture 116 may need to be decoded first, in order to act as a reference picture for picture 108. Likewise, picture 108 may act as a reference picture for pictures 104, 106, 110, and 112, and therefore may need to be decoded before pictures 104, 106, 110, and 112.

Moreover, in accordance with the techniques of this disclosure, a video coder may code POC values for pictures 100-132. For example, pictures 100, 116, and/or 132 may represent examples of IDR pictures. Pictures 100, 116, and 132 may also represent pictures at a temporal layer of zero, while pictures 108 and 124 may represent examples of pictures at temporal layer one, pictures 104, 112, 120, and 128 may represent examples of pictures at temporal layer two, and pictures 102, 106, 110, 114, 118, 122, 126, 130 may represent examples of pictures at temporal layer three. Thus, the POC values of pictures 100-132 may be coded, in accordance with the example techniques of this disclosure, based on whether the pictures are random access points, and if so, what type of random access point, and/or based on a temporal layer of the pictures, among other possible characteristics.

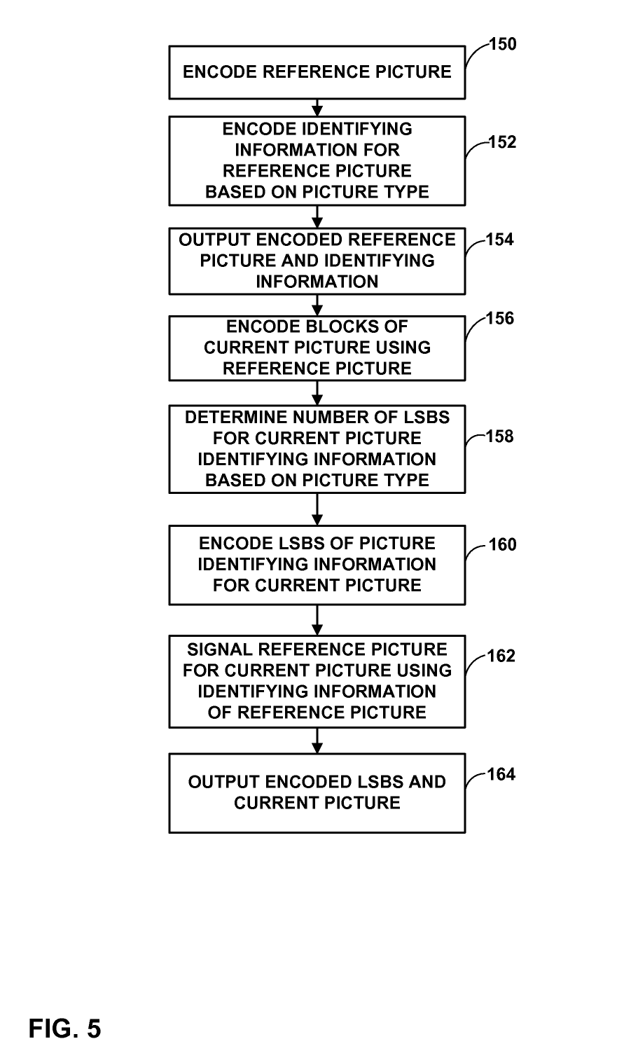

FIG. 5 is a flowchart illustrating an example method for encoding pictures and picture identifying information. Although explained primarily with respect to video encoder 20 of FIGS. 1 and 2, it should be understood that other types of devices may be configured to perform substantially similar techniques to those described with respect to FIG. 5.

In this example, video encoder 20 encodes a reference picture (150). For example, the reference picture may comprise an instantaneous decoder refresh (IDR) picture. Alternatively, the reference picture may comprise a non-IDR random access point picture, such as a clean random access (CRA) picture, or a non-random access point picture. In various examples, video encoder 20 may determine a number of least significant bits (LSBs) to be coded as identifying information for the reference picture based on a picture type for the reference picture. As one example, if the reference picture is an IDR picture, video encoder 20 may determine that zero LSBs are to be coded, and if the reference picture is a non-IDR picture, a predetermined number of LSBs are to be coded. Other examples are described above with respect to, e.g., Tables 1-3. Although described above as being based on a picture type for the reference picture, video encoder 20 may further determine the number of LSBs based on a temporal layer for the reference picture. Thus, either or both of the picture type and/or the temporal layer for the reference picture may provide an indication of a number of LSBs to be coded for a POC value of the reference picture.

For example, the number of LSBs may be based on whether the reference picture is a random access point (RAP), and if the reference picture is a RAP, whether the reference picture is an IDR, CRA, or GDR picture. As shown above, in one example, the number of LSBs is equal to 32 bits when the picture is a CRA picture, 16 bits when the picture is not a CRA picture and is not an IDR picture and is at temporal layer 0, 8 bits when the picture is in one of temporal layers 1 and 2, and 4 bits when the picture is in a temporal layer greater than 2. As another example, the number of LSBs is equal to 16 bits when the picture is a CRA picture, 8 bits when the picture is not a CRA picture and is not an IDR picture and is at temporal layer 0, 6 bits when the picture is in temporal layer 1, and 4 bits when the picture is in a temporal layer greater than 1. In some examples, video encoder 20 may code an indication of the number of LSBs to be coded for each picture type and/or each temporal layer in a parameter set, such as a sequence parameter set (SPS), a picture parameter set (PPS), or a video parameter set (VPS).

Accordingly, video encoder 20 may encode identifying information for the reference picture based on a picture type for the reference picture (152). The identifying information may comprise the determined number of LSBs of a picture order count (POC) value for the reference picture. In particular, video encoder 20 may determine a POC value of a previous picture in decoding order and determine values for the LSBs of a current POC value of the current reference picture relative to the previous reference picture. The previous reference picture may have a temporal layer value that is less than or equal to the temporal layer value of the current reference picture. Video encoder 20 may further output the encoded reference picture and the identifying information for the reference picture (154). In addition, video encoder 20 may decode the encoded version of the reference picture, and store data for the decoded version of the reference picture in reference frame memory 64.

Video encoder 20 may further encode one or more blocks of a current picture using the reference picture (156), where the current picture follows, and is distinct from, the reference picture in coding order. That is, video encoder 20 may inter-predict the one or more blocks relative to the reference picture. In addition, video encoder 20 may determine a number of LSBs to be coded for identifying information of the current picture based on a picture type for the current picture (158). In the example of FIG. 5, the current picture is not an IDR picture, and therefore, video encoder 20 may determine that the LSBs are to conform to a predetermined number of LSBs, e.g., for non-IDR pictures or for other, additional picture type information (e.g., whether the picture is a CRA picture or at a particular temporal layer). As discussed above, video encoder 20 may determine the number of LSBs based on a picture type and/or a temporal layer for the current picture, e.g., whether the current picture is a RAP picture, and if so, whether the current RAP picture is an IDR, CRA, or GDR picture, and/or based on a temporal layer for the current picture.

In any case, video encoder 20 may encode LSBs of the picture identifying information (e.g., POC value) for the current picture (160). For example, video encoder 20 may encode a value for the pic_order_cnt_lsb syntax element discussed with respect to Table 4 above. Video encoder 20 may also signal the reference picture for the current picture using the identifying information of the reference picture (162). More particularly, video encoder 20 may signal the POC value of the reference picture as being one picture to be included in a list of reference pictures for decoding the current picture. Video encoder 20 may signal this information as part of the ref_pic_list modification( ) syntax data of Table 4, or as other syntax data for the current picture. Video encoder 20 may also output the encoded LSBs and current picture (164). In this manner, the current picture may be used as a reference picture for subsequently coded pictures. Video encoder 20 may further signal a POC value for the current picture, in order for the current picture to be included in a list of reference pictures for the subsequently coded pictures.

In this manner, the method of FIG. 5 represents an example of a method including determining a number of least significant bits of picture identifying information for a picture of video data based on a picture type for the picture, determining a value of the picture identifying information for the picture, and coding information indicative of the determined number of least significant bits of the value of the picture identifying information for the picture.

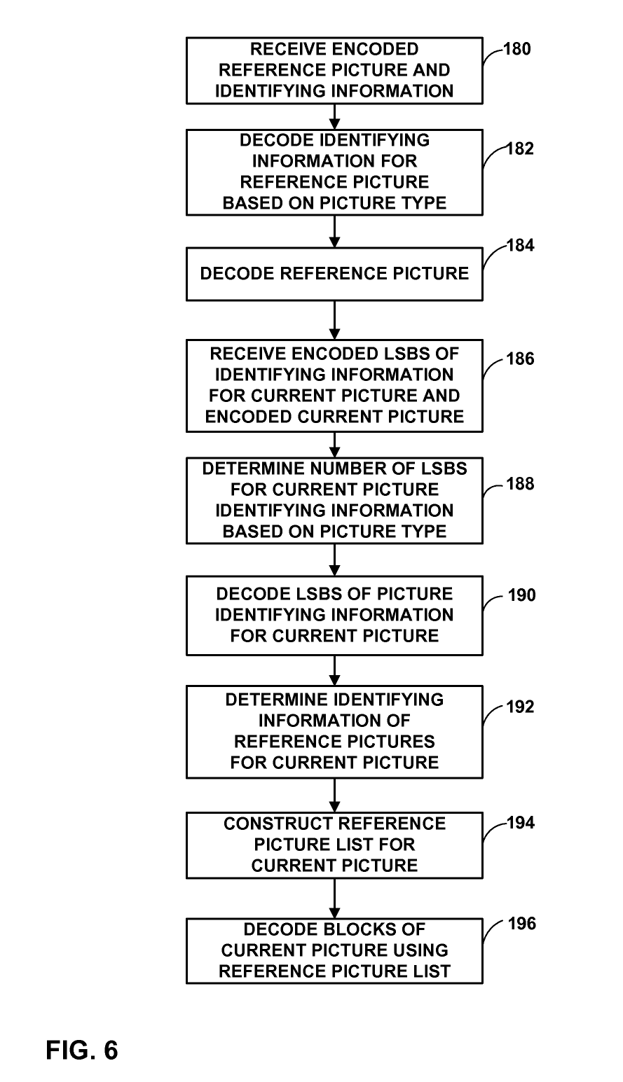

FIG. 6 is a flowchart illustrating an example method for encoding pictures and picture identifying information. Although explained primarily with respect to video decoder 30 of FIGS. 1 and 3, it should be understood that other types of devices may be configured to perform substantially similar techniques to those described with respect to FIG. 6.

Video decoder 30 may receive an encoded reference picture and, potentially, identifying information for the reference picture (180). In one example, if the reference picture is an IDR picture, video decoder 30 need not receive identifying information (e.g., a POC value) for the reference picture. In this example, if the reference picture is not an IDR picture, video decoder 30 may receive identifying information for the reference picture. Moreover, video decoder 30 may decode the identifying information for the reference picture based on a picture type for the reference picture (182). Again, in some examples, video decoder 30 may be configured to determine that a POC value for an IDR picture is zero, but video decoder 30 may decode LSBs of POC values for other types of pictures, where lengths of the LSBs may be determined based on a picture type. Furthermore, video decoder 30 may decode the reference picture (184) and store the decoded reference picture in reference frame memory 82.

Video decoder 30 may also receive encoded LSBs of identifying information (e.g., a POC value) for a current picture, as well as an encoded version of the current picture (186). Video decoder 30 may determine a number of LSBs for the current picture identifying information based on a picture type for the current picture (188). In this example, the current picture represents a non-IDR picture, and may therefore have a non-zero-length LSBs value. Video decoder 30 may further decode the LSBs of the picture identifying information for the current picture (190). Video decoder 30 may also reconstruct a full POC value for the current picture using the LSBs and a POC value of a previously coded picture (e.g., the reference picture or an intervening picture), as discussed with respect to the pseudocode described above with respect to FIG. 1.

Video decoder 30 may also determine identifying information for one or more reference pictures (192), including the reference picture decoded at step 184. Video decoder 30 may further construct a reference picture list (e.g., List 0 and/or List 1) for the current picture (194) using the identifying information for the one or more reference pictures. It is assumed that one or more blocks of the current picture are predicted from the reference picture decoded at step 184, for purposes of example. Therefore, video decoder 30 may then decode blocks of the current picture using the reference picture list (196), i.e., using one or more reference pictures identified in the reference picture list, which may include decoding one or more blocks relative to the reference picture that was decoded at step 184. In particular, motion compensation unit 72 may determine predictive data for the one or more blocks using data of the reference picture. Likewise, video decoder 30 may use the current picture as a reference picture for decoding a subsequent picture in decoding order, assuming the POC value for the current picture is used to construct a reference picture list for the subsequent picture.

In this manner, the method of FIG. 6 represents an example of a method including determining a number of least significant bits of picture identifying information for a picture of video data based on a picture type for the picture, determining a value of the picture identifying information for the picture, and coding information indicative of the determined number of least significant bits of the value of the picture identifying information for the picture.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
determining a number of least significant bits of picture identifying information for a picture of video data based on a picture type for the picture;
determining a value of the picture identifying information for the picture; and
coding information indicative of the determined number of least significant bits of the value of the picture identifying information for the picture.

2. The method of claim 1, wherein coding the information indicative of the determined number of least significant bits comprises coding data representative of the picture type, and wherein determining the number of least significant bits comprises determining that the number of least significant bits comprises zero when the picture type comprises an instantaneous decoder refresh (IDR) picture.

3. The method of claim 2, wherein when the picture type comprises a picture type other than an IDR picture, the method further comprises coding a pic_order_cnt_lsb syntax element having a length equal to the determined number of least significant bits, wherein the pic_order_cnt_lsb syntax element comprises a value corresponding to the least significant bits of the picture identifying information for the picture.

4. The method of claim 2, wherein determining the number of the least significant bits based on the picture type comprises determining whether the picture is a random access point, and when the picture is a random access point, the method further comprises determining whether the picture is an instantaneous decoder refresh random access point, a clean random access picture, or a gradual decoding refresh picture.

5. The method of claim 2, wherein determining the number of least significant bits based on the picture type comprises determining that the number of bits is equal to 32 bits when the picture is a clean random access picture, 16 bits when the picture is not a clean random access picture and is not an instantaneous decoder refresh (IDR) picture and is at temporal layer 0, 8 bits when the picture is in one of temporal layers 1 and 2, and 4 bits when the picture is in a temporal layer greater than 2.

6. The method of claim 2, wherein determining the number of least significant bits based on the picture type comprises determining that the number of bits is equal to 16 bits when the picture is a clean random access picture, 8 bits when the picture is not a clean random access picture and is not an IDR picture and is at temporal layer 0, 6 bits when the picture is in temporal layer 1, and 4 bits when the picture is in a temporal layer greater than 1.

7. The method of claim 2, wherein determining the number of the least significant bits based on the picture type further comprises determining the number of the least significant bits based on a temporal layer to which the picture corresponds and the picture type.

8. The method of claim 2, wherein the picture identifying information comprises a current picture order count (POC) value, wherein the picture comprises a current picture, and wherein determining the value of the picture identifying information comprises:
determining a previous POC value of a previous picture in decoding order; and
determining the current POC value relative to the previous POC value, using information signaled in a slice header for the current picture.

9. The method of claim 7, wherein the previous picture comprises a previous reference picture having a temporal layer value that is less than or equal to a temporal layer value of the current picture.

10. The method of claim 2, further comprising coding information indicative of the number of the least significant bits in a parameter set corresponding to the picture.

11. The method of claim 2, wherein the number of the least significant bits is signaled in a parameter set corresponding to the picture, the method further comprising:
coding information of the parameter set indicative of a minimum number of least significant bits used to represent picture identifying information for pictures corresponding to the parameter set; and
coding information of the parameter set defining one or more pairs of values, each of the pairs of values comprising a temporal layer value and a number of least significant bits used to represent picture identifying information pictures at the corresponding temporal layer.

12. The method of claim 2, wherein the number of the least significant bits is signaled in a parameter set corresponding to the picture, the method further comprising:
coding information of the parameter set indicative of a minimum number of least significant bits used to represent picture identifying information for pictures corresponding to the parameter set; and
coding information of the parameter set indicative of numbers of least significant bits used to represent picture identifying information for pictures at each of one or more temporal layers.

13. The method of claim 2, wherein coding the information indicative of the determined number of least significant bits comprises encoding the information indicative of the determined number of least significant bits.

14. The method of claim 2, wherein coding the information indicative of the determined number of least significant bits comprises decoding the information indicative of the determined number of least significant bits, and wherein determining the number of least significant bits comprises determining the number of least significant bits based at least in part on the decoded information.

15. A device for coding video data, the device comprising a video coder configured to determine a number of least significant bits of picture identifying information for a picture of video data based on a picture type for the picture, determine a value of the picture identifying information for the picture, and code information indicative of the determined number of least significant bits of the value of the picture identifying information for the picture.

16. The device of claim 15, wherein to code the information indicative of the determined number of least significant bits, the video coder is configured to code data representative of the picture type, and wherein to determine the number of least significant bits, the video coder is configured to determine that the number of least significant bits comprises zero when the picture type comprises an instantaneous decoder refresh (IDR) picture.

17. The device of claim 16, wherein the video coder is further configured to code a pic_order_cnt_lsb syntax element having a length equal to the determined number of least significant bits when the picture type comprises a picture type other than an IDR picture, and wherein the pic_order_cnt_lsb syntax element comprises a value corresponding to the least significant bits of the picture identifying information for the picture.

18. The device of claim 16, wherein to determine the number of the least significant bits based on the picture type, the video coder is configured to determine whether the picture is a random access point, and when the picture is a random access point, and the video coder is configured to determine whether the picture is an instantaneous decoder refresh random access point, a clean random access picture, or a gradual decoding refresh picture.

19. The device of claim 16, wherein the video coder is configured to determine the number of least significant bits based on a temporal layer to which the picture corresponds and the picture type.

20. The device of claim 16, wherein the picture identifying information comprises a current picture order count (POC) value, wherein the picture comprises a current picture, and wherein to determine the value of the picture identifying information, the video coder is configured to determine a previous POC value of a previous picture in decoding order, and determine the current POC value relative to the previous POC value, using information signaled in a slice header for the current picture.

21. The device of claim 16, wherein the video coder is further configured to code information indicative of the number of the least significant bits in a parameter set corresponding to the picture.

22. The device of claim 16, wherein the number of the least significant bits is signaled in a parameter set corresponding to the picture, and wherein the video coder is configured to code information of the parameter set indicative of a minimum number of least significant bits used to represent picture identifying information for pictures corresponding to the parameter set, and code information of the parameter set defining one or more pairs of values, each of the pairs of values comprising a temporal layer value and a number of least significant bits used to represent picture identifying information pictures at the corresponding temporal layer.

23. The device of claim 16, wherein the number of the least significant bits is signaled in a parameter set corresponding to the picture, and wherein the video coder is configured to code information of the parameter set indicative of a minimum number of least significant bits used to represent picture identifying information for pictures corresponding to the parameter set, and code information of the parameter set indicative of numbers of least significant bits used to represent picture identifying information for pictures at each of one or more temporal layers.

24. The device of claim 16, wherein the video coder comprises a video encoder, and wherein to code the information indicative of the determined number of least significant bits, the video encoder is configured to encode the information indicative of the determined number of least significant bits.

25. The device of claim 16, wherein the video coder comprises a video decoder, and wherein to code the information indicative of the determined number of least significant bits, the video decoder is configured to decode the information indicative of the determined number of least significant bits, and wherein to determine the number of least significant bits, the video decoder is configured to determine the number of least significant bits based at least in part on the decoded information.

26. The device of claim 15, wherein the device comprises at least one of:
an integrated circuit;
a microprocessor; and
a wireless communication device that includes the video coder.

27. A device for coding video data, the device comprising:
means for determining a number of least significant bits of picture identifying information for a picture of video data;
means for determining a value of the picture identifying information for the picture; and
means for coding information indicative of the determined number of least significant bits of the value of the picture identifying information for the picture.

28. A computer-readable storage medium having stored thereon instructions that, when executed, cause one or more processors to:
determine a number of least significant bits of picture identifying information for a picture of video data based on a picture type for the picture;
determine a value of the picture identifying information for the picture; and
code information indicative of the determined number of least significant bits of the value of the picture identifying information for the picture.

29. The computer-readable storage medium of claim 28, wherein the instructions that cause the processor to code the information indicative of the determined number of least significant bits comprise instructions that cause the processor to code data representative of the picture type, and wherein the instructions that cause the processor to determine the number of least significant bits comprise instructions that cause the processor to determine that the number of least significant bits comprises zero when the picture type comprises an instantaneous decoder refresh (IDR) picture.

30. The computer-readable storage medium of claim 29, further comprising instructions that cause the processor to, when the picture type comprises a picture type other than an IDR picture, code a pic_order_cnt_lsb syntax element having a length equal to the determined number of least significant bits, wherein the pic_order_cnt_lsb syntax element comprises a value corresponding to the least significant bits of the picture identifying information for the picture.

31. The computer-readable storage medium of claim 29, wherein the instructions that cause the processor to determine the number of the least significant bits based on the picture type comprise instructions that cause the processor to determine whether the picture is a random access point, and when the picture is a random access point, further comprising instructions that cause the processor to determine whether the picture is an instantaneous decoder refresh random access point, a clean random access picture, or a gradual decoding refresh picture.

32. The computer-readable storage medium of claim 29, wherein the instructions that cause the processor to determine the number of the least significant bits based on the picture type further comprises instructions that cause the processor to determine the number of the least significant bits based on a temporal layer to which the picture corresponds and the picture type.

33. The computer-readable storage medium of claim 29, wherein the picture identifying information comprises a current picture order count (POC) value, wherein the picture comprises a current picture, and wherein the instructions that cause the processor to determine the value of the picture identifying information comprise instructions that cause the processor to:
determine a previous POC value of a previous picture in decoding order; and
determine the current POC value relative to the previous POC value, using information signaled in a slice header for the current picture.

34. The computer-readable storage medium of claim 29, further comprising instructions that cause the processor to code information indicative of the number of the least significant bits in a parameter set corresponding to the picture.

35. The computer-readable storage medium of claim 29, wherein the number of the least significant bits is signaled in a parameter set corresponding to the picture, further comprising instructions that cause the processor to:
code information of the parameter set indicative of a minimum number of least significant bits used to represent picture identifying information for pictures corresponding to the parameter set; and
code information of the parameter set defining one or more pairs of values, each of the pairs of values comprising a temporal layer value and a number of least significant bits used to represent picture identifying information pictures at the corresponding temporal layer.

36. The computer-readable storage medium of claim 29, wherein the number of the least significant bits is signaled in a parameter set corresponding to the picture, further comprising instructions that cause the processor to:
code information of the parameter set indicative of a minimum number of least significant bits used to represent picture identifying information for pictures corresponding to the parameter set; and
code information of the parameter set indicative of numbers of least significant bits used to represent picture identifying information for pictures at each of one or more temporal layers.

37. The computer-readable storage medium of claim 29, wherein the instructions that cause the processor to code the information indicative of the determined number of least significant bits comprise instructions that cause the processor to encode the information indicative of the determined number of least significant bits.

38. The computer-readable storage medium of claim 29, wherein the instructions that cause the processor to code the information indicative of the determined number of least significant bits comprise instructions that cause the processor to decode the information indicative of the determined number of least significant bits, and wherein the instructions that cause the processor to determine the number of least significant bits comprise instructions that cause the processor to determine the number of least significant bits based at least in part on the decoded information.
